(19) United States
(12) Patent Application Publication
(10) Pub. No.: US 2008/0155054 A1
(43) Pub. Date: Jun. 26, 2008

(54) APPARATUS AND METHOD FOR SETTING DATA IN PORTABLE COMMUNICATION SYSTEM

(75) Inventor: Jin-Chul CHOI, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD, Suwon-si (KR)

(21) Appl. No.: 11/960,276

(22) Filed: Dec. 19, 2007

(30) Foreign Application Priority Data
Dec. 22, 2006 (KR) 2006-0133040

(51) Int. Cl. G06F 15/16

(52) U.S. Cl. 709/217

(57) ABSTRACT

Provided are an apparatus and a method for providing information of set data to a user (pre-registered user) who can share the set data. The apparatus includes a communicator instructed by a controller to transmit information of the set data to a receiving portable terminal; and if a set data input event occurs, the controller outputting a set data input screen to receive the set data, generating a set data message including the set data, and transmitting the set data message to the receiving portable terminal.

### PRIORITY

This application claims priority under 35 U.S.C. §119 to an application filed in the Korean Intellectual Property Office on Dec. 22, 2006 and assigned Serial No. 2006-0133040, the contents of which are incorporated herein by reference.

### BACKGROUND OF THE INVENTION

1. Field of the Invention

The present invention relates generally to an additional function of a portable terminal, and in particular, to an apparatus and a method for providing information of set data to a user, i.e., a pre-registered user, who can share the set data.

2. Description of the Related Art

Portable terminals have recently become necessities by people of all ages. Also, service providers and portable terminal manufacturers have competitively developed products or services which are different from other enterprises.

For example, portable terminals have developed into multimedia devices which provide various services including phonebook, games, short message service, e-mail, morning or wake-up call, Motion Picture Experts Group (MPEG) Layer 3 (MP3), schedule management function, digital camera and wireless Internet services.

In particular, the schedule management function is one of the additional functions which are used by a large number of users to overcome the inconvenience of directly making memorandums of schedules using tools, such as notes, whenever the users manage the schedules.

However, the schedule management function only inputs simple schedule information. Thus, a user may set and confirm a schedule using the schedule management function.

In other words, the schedule management function is provided only to directly communicate with a caller so as to set schedules according to date and confirm the set schedules using an alarm or the like. Thus, if the schedules are to be changed, a user must communicate with a caller to change the schedules.

Accordingly, there is required a method of requesting a search for a schedule using a portable terminal, receiving the schedule from a user who has the schedule, searching for a date on which an additional schedule can be set, and setting a schedule.

### SUMMARY OF THE INVENTION

An aspect of the present invention is to substantially solve at least the above problems and/or disadvantages and to provide at least the advantages below. Accordingly, an aspect of the present invention is to provide an apparatus and a method for providing information set in a portable terminal to a user who can share the information.

Another aspect of the present invention is to provide an apparatus and a method for generating a response message corresponding to set data in a portable terminal which has received set information.

A further aspect of the present invention is to provide an apparatus and a method for transmitting a response message generated in a portable terminal, which has received set information, to a portable terminal which has transmitted the set information.

According to one aspect of the present invention, there is provided an apparatus for managing set data, including a communicator instructed by a controller to transmit information of the set data to a receiving portable terminal; and if a set data input event occurs, the controller outputting a set data input screen to receive the set data, generating a set data message including the set data, and transmitting the set data message to the receiving portable terminal.

According to another aspect of the present invention, there is provided a method of inputting set data in a portable terminal, including if a request for an input of the set data is sensed, outputting a set data input screen and inputting information of the set data; if the set data is completely input, generating a set data message which includes the set data; and transmitting the set data message to receiving portable terminals which are registered in the set data.

According to a further aspect of the present invention, there is provided a method of processing set data in a portable terminal which has received a set data message, including if a set data message is received, outputting information of set data which is included in the set data message; generating a response message to the set data message; and transmitting the response message to a portable terminal which has transmitted the set data message.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a portable terminal into which set data can be input, according to the present invention;

FIG. 2 is a flowchart of a process of generating set data in a portable terminal according to the present invention;

FIG. 3 is a flowchart of a process of changing set data in a portable terminal according to the present invention;

FIG. 4 is a flowchart of a process of processing set data in a portable terminal, which has received a set data message, according to the present invention; and

FIGS. 5A through 5C illustrate screens of a portable terminal generating set data according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides an apparatus and a method for transmitting set data, which is information to be input into a portable terminal, to a user who can share the set data, in order to receive a response to the input information.

Here, the set data may include at least one of schedule setting, schedule changing, memorandum writing, memorandum changing, address book writing, and address book changing.

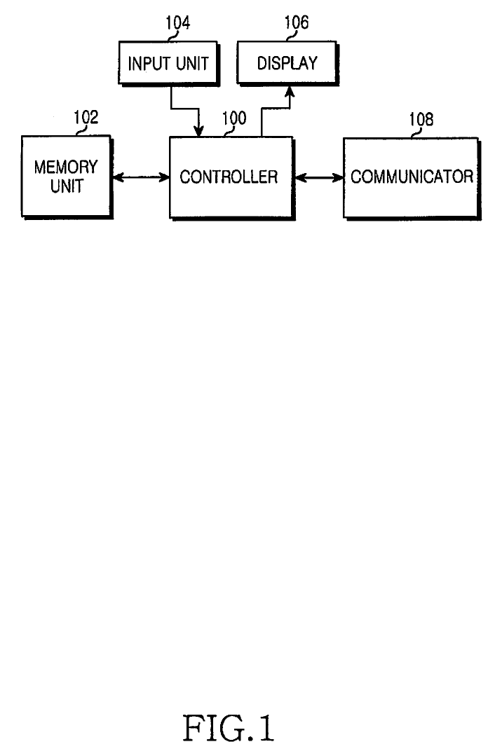

FIG. 1 is a block diagram of a portable terminal into which set data can be input, according to the present invention. Here, examples of the portable terminal may include mobile communication terminals including a cellular phone, a Personal Communication System (PCS) terminal, a Personal Data Assistant (PDA), an International Mobile Telecommunication-2000 (IMT-2000) terminal, and a fourth generation (4G) broadband system. Hereinafter, the portable terminal of the present invention will be described with general structures of the above terminals.

Referring to FIG. 1, the portable terminal includes a controller 100, a memory unit 102, an input unit 104, a display 106, and a communicator 108.

The controller 100 controls an overall operation of the portable terminal. For example, the controller 100 performs processing and controlling for voice and data communications. According to the present invention, besides the normal processing and controlling function, if the controller 100 senses a set data input request, the controller 100 controls the display 106 to display a set data input screen. If the controller 100 senses that a user has completely input set data, the controller 100 generates a message including the set data and transmit the message to users who are related to the set data.

If the controller 100 receives response messages to the message from the users, the controller 100 outputs formation included in the response messages to the display 106.

The memory unit 102 includes a read only memory (ROM), a random access memory (RAM), and a flash ROM. The ROM stores micro-codes of a program for processing and controlling operations of the controller 100 and various types of reference data.

The RAM is a working memory of the controller 100 and stores temporary data which is generated during execution of various programs. The flash ROM stores various updatable types of storage data including a phonebook, a transmitted message, and a received message. According to the present invention, the flash ROM may store the set data.

The input unit 104 includes a plurality of function keys including numeral key buttons from “0” to “9,” a menu button, a cancel (delete) button, a confirm button, a talk button, an end button, an Internet access button, navigation key (direction key) buttons, character input keys, etc. The input unit 104 provides the controller 100 with key input data corresponding to a key pressed by the user, e.g., the set data input request, a schedule change request, etc.

The display 106 displays state information, limited numerical characters, a plurality of moving pictures, and a plurality of still pictures, etc. which are generated during the operation of the portable terminal. The display 106 may be a color liquid crystal display (LCD).

The communicator 108 transmits and/or receives a radio frequency (RF) signal of data which is input and output through an antenna (not shown). For example, if the communicator 108 transmits the RF signal, the communicator 108 performs channel coding and spreading on data to be transmitted, up converts the RF signal, and transmits the RF signal. If the communicator 108 receives the RF signal, the communicator 108 converts the RF signal into a baseband signal and performs de-spreading and channel decoding on the baseband signal to recover the data.

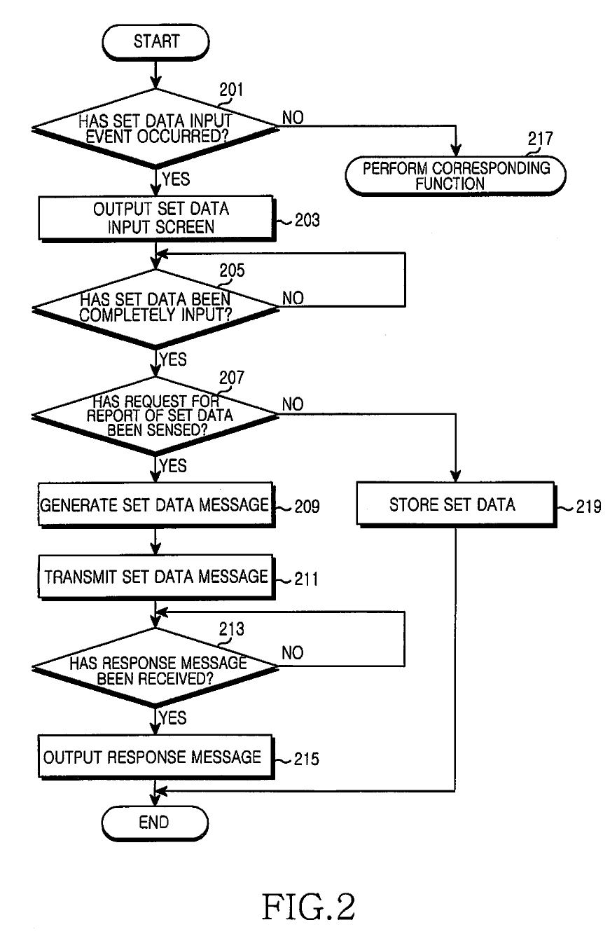

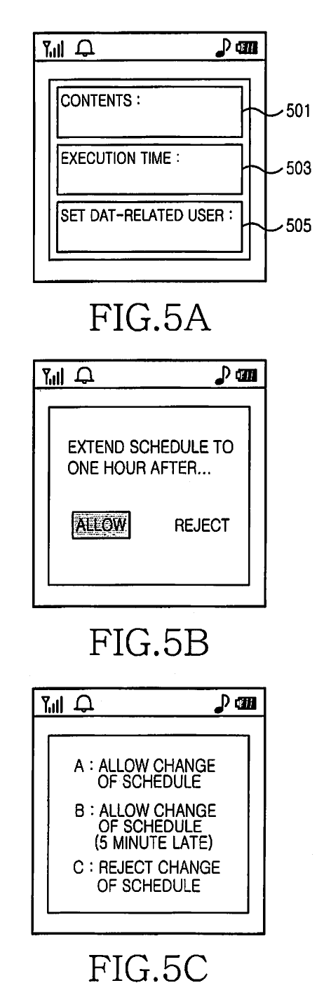

FIG. 2 is a flowchart of a process of generating set data in a portable terminal according to the present invention, and FIG. 5A illustrates a screen of a portable terminal generating set data according to an embodiment of the present invention. Referring to FIG. 2, in step 201, the controller 100 of the portable terminal determines whether a set data input event has occurred by a user. Here, the set data may include schedule setting, schedule changing, memorandum writing, memorandum changing, address book writing, address book changing, etc.

If it is determined in step 201 that the set data input event has not occurred, the controller 100 goes to step 217 to perform a corresponding function, e.g., a standby mode.

If it is determined in step 201 that the set data input event has occurred, the controller 100 proceeds to step 203 to output a set data input screen to the display 106. Here, as shown in FIG. 5A, the set data input screen may include a content item 501 of data a user desires to set, an execution time item 503 of the set data, and an item 505 for registering a user related to the set data. Please correct “Data” to “Data” in box 505 of FIG. 5A.

For example, if the user of the portable terminal desires to set a schedule for a “Customer Meeting,” the user may set the schedule “Customer Meeting” in content item 501 and a customer meeting time in execution time item 503. Also, portable terminal numbers of users attending the customer meeting may be input and registered in item 505.

In step 205, the controller 100 determines whether the user has completely input the set data. If it is determined in step 205 that the user has not completely input the set data, the controller 100 re-performs step 205.

If it is determined in step 205 that the user has completely input the set data, the controller 100 proceeds to step 207 to determine whether the user has sensed a request for a report of the set data. Here, the request for the report of the set data refers to a process of transmitting information set by the user to set data-related users.

If it is determined in step 207 that the user has not sensed the request for the report of the set data, the controller 100 goes to step 219 to store the input set data in the memory unit 102 of the portable terminal and then ends the present process.

If it is determined in step 207 that the user has sensed the request for the report of the set data, the controller 100 proceeds to step 209 to generate a set data message including the set data. In step 211, the controller 100 transmits the set data message to the set data-related users.

In step 213, the controller 100 determines whether response messages to the set data message have been received from the set-data related users. Here, the response messages may include opinions and comments of the set data-related users on the set data.

If it is determined in step 213 that the response messages have been received from the set data-related users, the controller 100 proceeds to step 215 to output contents of the received response messages to the display 106.

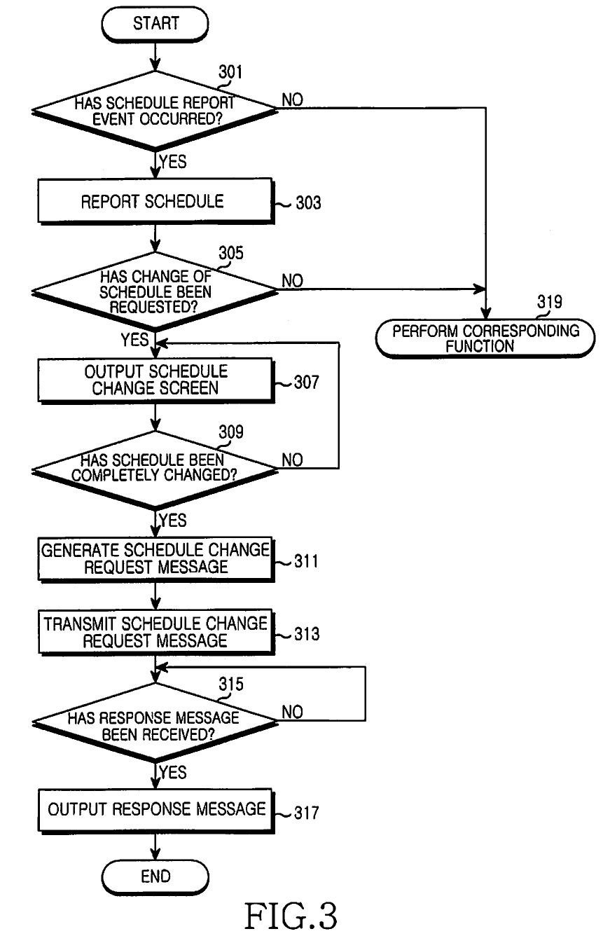

Here, the contents of the received response messages may include information which includes the set data-related users who have transmitted the response messages and the opinions and comments of the set data-related users on the set data. The contents of the received response messages will be described in detail with reference to FIG. 3.

The controller 100 then ends the present process.

FIG. 3 is a flowchart of a process of changing set data in a portable terminal according to the present invention. Here, a method of changing a pre-set schedule of the set data will be described with reference to FIGS. 3 and 5B and 5C.

Referring to FIG. 3, in step 301, the controller 100 of the portable terminal determines whether a schedule report event has occurred. Here, the schedule report event refers to an event for providing information regarding a schedule set by a user to the user before a predetermined time (e.g., one hour ago, two hour ago, etc.).

If it is determined in step 301 that the schedule report event has not occurred, the controller 100 goes to step 319 to perform a corresponding function, e.g., a standby mode.

If it is determined in step 301 that the schedule report event has occurred, the controller 100 proceeds to step 303 to output the schedule report event to the display 106 so as to report the schedule to a user. Here, the schedule may be reported to the user using an alarm or a vibration.

In step 305, the controller 100 determines whether the user has requested a change of the schedule. Here, the request for the change of the schedule refers to a request for a change of a setup of a pre-set schedule. If there is no such request, the controller goes to step 319 to perform a corresponding function, e.g., a standby mode.

If it is determined in step 305 that the user has requested the change of the schedule, the controller 100 proceeds to step 307 to output a schedule change screen to the display 106. Here, the schedule change screen may be similar to 30 the set data input screen described with reference to FIG. 2 and include contents of a schedule a user desires to set, a schedule setup time, an item for registering a schedule-related user, etc.

The setup of the schedule may be changed using a specific key. For example, if the user desires to re-set a setup time of the set schedule to one hour later, the user may press a “*” button of the input unit 104 of the portable terminal and then long press a numeral button “1” in order to re-set the setup time of the schedule.

If the user desires to change the setup time of the schedule to one hour before, the user may press a “#” button of the input unit 104 of the portable terminal and then long press the numeral button “1” in order to re-set the setup time of the schedule.

In step 309, the controller 100 determines whether the user has completely changed the schedule. If it is determined in step 309 that the user has completely changed the schedule, the controller 100 proceeds to step 311 to generate a schedule change request message. If not, the controller returns to step 307.

For example, if the user checks information regarding the set schedule one hour before the setup time of the schedule and thus desires to set the setup time of the schedule to one hour after the setup time, the controller 100 generates a message including information regarding the changed time of the schedule.

In step 313, the controller 100 transmits the schedule change message to schedule-related users. Here, the schedule-related users refer to users who are registered as set data-related users during setting of the schedule as described with reference to FIG. 2.

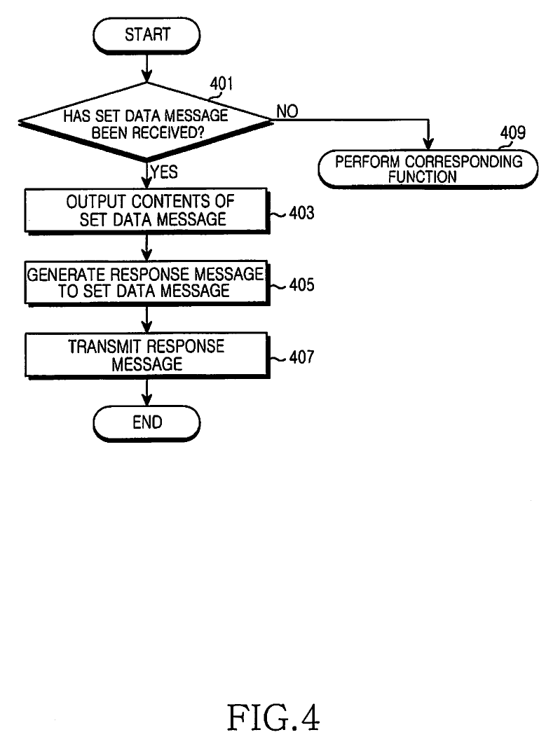

In step 315, the controller 100 determines whether response messages to the schedule change message have been received from the schedule-related users. If so, the controller proceeds to step 317. If not, the controller returns to step 315. The response messages will be described in detail later with reference to FIG. 4.

In step 317, the controller 100 outputs the response messages to the display 106.

Here, the response messages may be output together with information regarding the schedule-related users and whether the change of the schedule has been allowed.

For example, schedule change allowance information, which is transmitted from users “A” and “B,” and schedule change rejection information, which is transmitted from a user “C,” may be output as shown in FIG. 5C. Predetermined characters (e.g., an opinion on the change of the schedule such as a reason for a rejection of the change of the schedule), which are input by the user “B,” may be also output.

The response messages may be output using an additional display depending on whether the change of the schedule has been allowed. For example, a user who has allowed the change of the schedule may express a response message with blue characters or a user who has rejected the change of the schedule may express a response message with red characters.

The controller 100 then ends the present process.

FIG. 4 is a flowchart of a process of processing set data in a portable terminal, which has received a set data message, according to the present invention. Also, FIGS. 5A through 5C illustrate the screens of the portable terminal generating the set data according to the present invention.

Referring to FIG. 4, in step 401, the controller 100 of the portable terminal determines whether a set data message has been received. If it is determined in step 401 that the set data message has not been received, the controller 100 goes to step 409 to perform a corresponding function, e.g., a standby mode.

If it is determined in step 401 that the set data message has been received, the controller 100 proceeds to step 403 to output contents of the set data message to the display 106. In step 405, the controller 100 generates a response message to the set data message.

The response message may include at least one of information of a user who accepts the set data, information of a user who rejects the set data, and an opinion or comment on the set data.

For example, if a schedule change request is received as shown in FIG. 5B, a user may press an allowance button to generate a schedule change allowance message or may press a rejection button to generate a schedule change rejection message.

The response message enables text to be input, and thus predetermined characters (e.g., reasons for the rejection of the schedule) to be input.

In step 407, the controller 100 transmits the response message to a portable terminal which has made the schedule change request and then ends the present process.

In accordance with the present invention as described above, set data may be generated or pre-stored set data may be changed using a portable terminal. In this case, information regarding the set data can be transmitted to a pre-registered receiver to communicate with a caller. As a result, inconvenience of the transmission of the information of the set data can be avoided.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for managing set data, comprising:
a communicator for transmitting set data message to a receiving portable terminal; and
a controller outputting a set data input screen to receive the set data, generating a set data message including the set data, and instructing the communicator to transmit the set data message to the receiving portable terminal.

2. The apparatus of claim 1, wherein if a response message to the set data message is received from the receiving portable terminal, the controller outputs contents of the response message.

3. The apparatus of claim 1, wherein the set data input screen comprises at least one of a content item of data to be set, an execution time item of the set data, and an item for registering a user related to the set data.

4. The apparatus of claim 3, wherein the set data is set or changed using a specific key of the portable terminal.

5. The apparatus of claim 2, wherein the response message received from the receiving portable terminal comprises at least one of information of a user who accepts the set data, information of a user who rejects the set data, and an opinion on the set data.

6. The apparatus of claim 5, wherein the set data comprises at least one of schedule setting, schedule changing, memorandum writing, memorandum changing, address book writing, and address book changing.

7. A method of inputting set data in a portable terminal, comprising:
inputting information of the set data;
if the set data is completely input, generating a set data message including the set data; and
transmitting the set data message to receiving portable terminals which are registered in the set data.

8. The method of claim 7, further comprising:
if the set data is to be changed, outputting a set data change screen and then changing the set data; and
generating the set data message including the changed set data and transmitting the set data message to the registered receiving portable terminals.

9. The method of claim 8, after transmitting the set data message, further comprising if response messages to the set data message are received from the receiving portable terminals, outputting information of the response messages.

10. The method of claim 9, wherein the response messages comprise at least one of information of a user who accepts the set data, information of a user who rejects the set data, and an opinion on the set data.

11. The method of claim 8, wherein the set data is set or changed using a specific key of the portable terminal.

12. The method of claim 8, wherein the set data comprises at least one of schedule setting, schedule changing, memorandum writing, memorandum changing, address book writing, and address book changing.

13. A method of processing set data in a portable terminal which has received a set data message, comprising:
if a set data message is received, outputting information of set data included in the set data message;
generating a response message to the set data message; and
transmitting the response message to a portable terminal which has transmitted the set data message.

14. The method of claim 13, wherein the response message comprises at least one of information of a user who accepts the set data, information of a user who rejects the set data, and an opinion on the set data.

15. The method of claim 14, wherein the set data comprises at least one of schedule setting, schedule changing, memorandum writing, memorandum changing, address book writing, and address book changing.
